(19) United States
(12) Patent Application Publication
(10) Pub. No.: US 2026/0301575 A1
(43) Pub. Date: Oct. 1, 2026

(54) METHOD AND DEVICE FOR PREVENTING FORWARD COLLISION OF VEHICLE

(71) Applicant: HYUNDAI MOBIS CO., LTD., Seoul (KR)

(72) Inventor: Cheol Ho Kim, Yongin-si (KR)

(73) Assignee: HYUNDAI MOBIS CO., LTD., Seoul (KR)

(21) Appl. No.: 19/377,588

(22) Filed: Nov. 3, 2025

(30) Foreign Application Priority Data
Mar. 27, 2025 (KR) 10-2025-0039600

(51) Int. Cl. G08G 1/16; B60W 30/16; B60W 40/04; B60W 40/105; B60W 50/14

(52) U.S. Cl. CPC G08G 1/166; B60W 30/162; B60W 40/04; B60W 40/105; B60W 50/14; B60W 2554/4041; B60W 2554/4042; B60W 2554/406; B60W 2554/802; B60W 2556/45; B60W 2720/10; B60W 2754/30

(57) ABSTRACT

A method for preventing a forward collision of a vehicle includes receiving preceding traffic information including a location of the vehicle, a travel route, and at least one preceding vehicle speed information, determining road congestion based on the preceding traffic information, outputting a congestion notification in response to the road congestion, determining whether to deactivate smart cruise control in response to the congestion notification, reducing a speed of the smart cruise control when the smart cruise control is not deactivated, increasing an inter-vehicle distance to a preceding vehicle based on the reduced smart cruise control speed, determining whether a distance to the preceding vehicle is equal to or smaller than a predetermined distance, and restoring a predetermined speed and an inter-vehicle distance when the distance to the preceding vehicle is equal to or smaller than the predetermined distance.

This application claims the benefit of Korean Patent Application No. 10-2025-0039600, filed on Mar. 27, 2025, which is hereby incorporated by reference as if fully set forth herein.

### BACKGROUND OF THE DISCLOSURE

### Field of the Disclosure

The present disclosure relates to a technology for preventing a forward collision of a vehicle using a smart cruise technology.

### Discussion of the Related Art

The present disclosure relates to a method for automatically setting a smart cruise control speed based on road traffic information and a smart cruise control system of a vehicle, and more specifically, to a technology capable of controlling, by a smart cruise control (SCC), a travel speed (hereinafter, referred to as an SCC speed) of the vehicle during travel based on road information system information when setting a cruise function or a speed limit function.

As functions of vehicles become more advanced, an SCC system, an electronic stability control (ESC) system, or the like that promotes safety of the vehicles is being installed. The SCC system, which is referred to as an inter-vehicle distance control device during the travel, provides the cruise function of sensing several hundred meters ahead with a radar sensor mounted at a front side of the vehicle and achieving automatic driving at a speed set by a driver while maintaining a predetermined distance from a vehicle ahead, or provides the speed limit function of controlling the speed of the vehicle so as not to exceed the speed set by the driver.

Such an SCC system is a function preferred by drivers because it is convenient for the drivers not to continuously manipulate an accelerator to adjust the travel speed of the vehicle, and it promotes safe driving by preventing the vehicle from traveling at a speed equal to or higher than a set speed. However, this SCC system has problems in that the vehicle is operated only at the speed set by the driver and there is a risk of a forward collision because of late recognition/braking when there is congestion at a long distance.

The matters described as the background of the present disclosure are only for enhancing understanding of the background of the present disclosure, and should not be construed as an acknowledgment that they correspond to the prior art already known to those of ordinary skill in the art.

### SUMMARY OF THE DISCLOSURE

The present disclosure is intended to provide a method and a device for preventing a forward collision of a vehicle that further improve an accident prevention effect of the vehicle and enable safer driving of the vehicle by controlling an SCC and an inter-vehicle distance in case of long-distance congestion and controlling a smart cruise control operation when entering a congestion section.

According to an aspect of the present disclosure, provided is a method for preventing a forward collision of a vehicle including receiving preceding traffic information including a location of the vehicle, a travel route, and at least one preceding vehicle speed information, determining road congestion based on the preceding traffic information, outputting a congestion notification in response to the road congestion, determining whether to deactivate smart cruise control in response to the congestion notification, reducing a speed of the smart cruise control when the smart cruise control is not deactivated, increasing an inter-vehicle distance to a preceding vehicle based on the reduced smart cruise control speed, determining whether a distance to the preceding vehicle is equal to or smaller than a predetermined distance, and restoring a predetermined speed and an inter-vehicle distance when the distance to the preceding vehicle is equal to or smaller than the predetermined distance.

In one implementation, the determining of the road congestion based on the preceding traffic information may include calculating an average speed based on the at least one preceding vehicle speed information, calculating a speed difference between the average speed and a current travel speed of the vehicle, and determining that there is the road congestion when the calculated speed difference is equal to or greater than a preset value.

In one implementation, the reducing of the smart cruise control speed may include determining a congestion level based on the calculated speed difference, and reducing a speed of the vehicle in a stepwise manner based on the determined congestion level.

In one implementation, the increasing of the inter-vehicle distance based on the reduced smart cruise control speed may include gradually increasing the inter-vehicle distance to the preceding vehicle in a stepwise manner based on the determined congestion level.

In one implementation, the determining of whether the distance to the preceding vehicle is equal to or smaller than the predetermined distance may include determining whether the distance to the preceding vehicle is the same as the inter-vehicle distance increased in the stepwise manner.

The present disclosure may further improve the accident prevention effect of the vehicle and enable the safer driving of the vehicle by providing a driving assistance function of predicting the road congestion ahead using road direction and topographical information and preventing the accident when the vehicle passes the congestion section.

Effects obtainable in the present disclosure are not limited to the effects mentioned above, and other effects not mentioned may be clearly understood by those skilled in the art to which the present disclosure pertains from the following description.

### BRIEF DESCRIPTION OF THE DRAWINGS

FIG. 1 is an overall block diagram of an autonomous driving control system to which an autonomous driving apparatus according to any one of embodiments of the present disclosure is applicable.

FIG. 2 is a diagram illustrating an example in which an autonomous driving apparatus according to any one of embodiments of the present disclosure is applied to a vehicle.

FIG. 3 is a diagram for illustrating a method for preventing a forward collision by adjusting an inter-vehicle distance in association with a preceding traffic situation during a smart cruise control operation of a vehicle according to an embodiment of the present disclosure.

FIG. 4 is a block diagram for illustrating a device for preventing a forward collision of a vehicle according to an embodiment of the present disclosure.

FIG. 5 is a diagram for illustrating a method for calculating a congestion level according to an embodiment of the present disclosure.

FIG. 6 is a flowchart for illustrating a method for preventing a forward collision of a vehicle according to one of embodiments of the present disclosure.

### DETAILED DESCRIPTION OF THE DISCLOSURE

Hereinafter, with reference to the accompanying drawings, embodiments of the present disclosure will be described in detail so that those skilled in the art can easily practice the present disclosure. However, the present disclosure may be implemented in various different forms and is not limited to the embodiments described herein. In addition, in the drawings, in order to clearly explain the present disclosure, parts that are not related to the description will be omitted, and the same or similar parts are denoted by the same reference numerals throughout the description.

Throughout the description, when a part is referred to as “including” an element, it may not mean that the part excludes other elements, but may mean that the part includes other elements, unless stated otherwise.

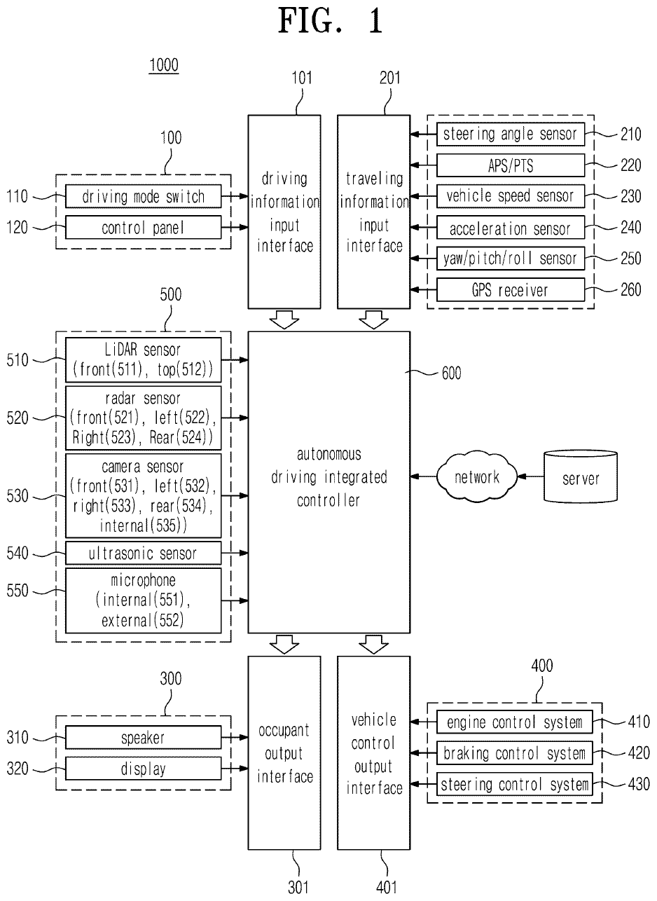

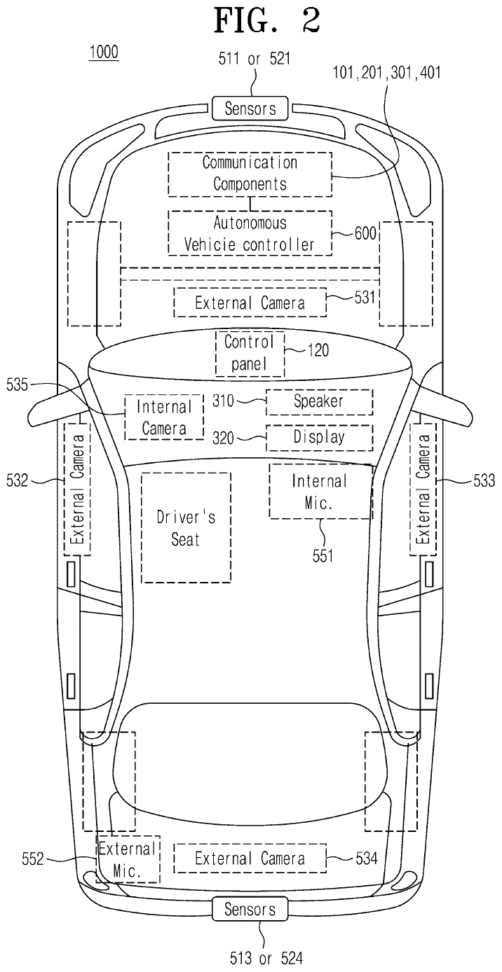

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

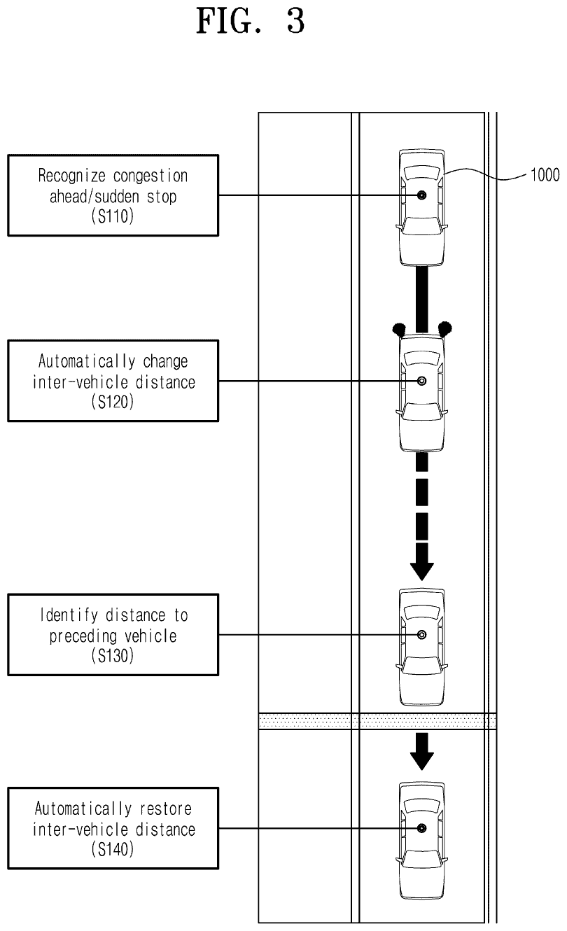

FIG. 3 is a diagram for illustrating a method for preventing a forward collision by adjusting an inter-vehicle distance in association with a preceding traffic situation during a smart cruise control operation of a vehicle according to an embodiment of the present disclosure.

Referring to FIG. 3, in the vehicle forward collision preventing method according to the present disclosure, situations of congestion ahead and sudden stop on a travel route may be recognized based on preceding traffic information received by the vehicle 1000 (S110).

The front traffic information may include speeds of preceding vehicles traveling ahead. The vehicle 1000 may determine a congestion time point on the route of the vehicle based on the periodically received preceding traffic information. Specifically, the vehicle 1000 may receive the preceding traffic information including a location of the vehicle, the travel route, and at least one preceding vehicle speed information.

The vehicle 1000 may determine road congestion based on the preceding traffic information. Specifically, the vehicle 1000 may periodically receive the traffic information from a server, and determine whether there is the congestion based on the speeds received from the preceding vehicles on the road and a current speed of the vehicle.

For example, the vehicle 1000 may calculate an average speed based on the at least one preceding vehicle speed information, calculate a speed difference between the average speed and the current speed of the vehicle, and determine the road congestion situation or the sudden stop situation when the calculated speed difference is equal to or greater than a predetermined value. Thereafter, the vehicle 1000 may output a congestion notification in response to the road congestion.

In addition, the vehicle 1000 may determine whether to deactivate a smart cruise control (SCC) in response to the congestion notification.

When the SCC is not deactivated, the vehicle 1000 may automatically change the inter-vehicle distance (S120).

The vehicle 1000 may adjust the inter-vehicle distance based on the smart cruise control operation. To this end, the vehicle 1000 may reduce an SCC speed and increase an inter-vehicle distance to the preceding vehicle based on the reduced SCC speed.

For example, the vehicle 1000 may gradually adjust the inter-vehicle distance. In this regard, the vehicle 100 may adjust a vehicle distance in a stepwise manner. Specifically, the vehicle 1000 may determine a congestion level based on the calculated speed difference, and may decrease the speed of the vehicle in the stepwise manner based on the determined congestion level. In addition, the vehicle 1000 may gradually increase the inter-vehicle distance to the preceding vehicle in the stepwise manner based on the congestion level. In this case, as the congestion level increases, the inter-vehicle distance may increase.

After adjusting the inter-vehicle distance, the vehicle 1000 may identify a distance to the preceding vehicle (S130). To this end, the vehicle 100 may determine whether the distance to the preceding vehicle is equal to or smaller than a predetermined distance, and determine whether the distance to the preceding vehicle is equal to or smaller than the predetermined distance. For example, it may be determined whether the distance to the preceding vehicle is the same as the inter-vehicle distance increased in the stepwise manner.

The vehicle 1000 may restore the inter-vehicle distance initially set by the driver based on the identified distance to the preceding vehicle (S140). For example, when the distance to the preceding vehicle is equal to or smaller than the predetermined distance, the vehicle 1000 may restore the predetermined speed and inter-vehicle distance.

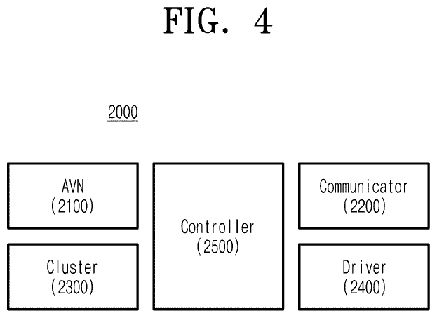

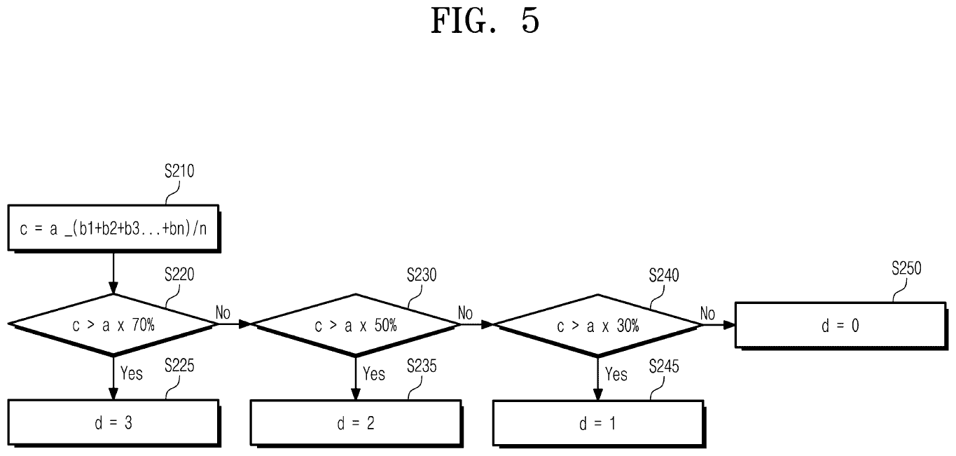

FIG. 4 is a block diagram for illustrating a device for preventing a forward collision of a vehicle according to an embodiment of the present disclosure. FIG. 5 is a diagram for illustrating a method for calculating a congestion level according to an embodiment of the present disclosure.

Referring to FIG. 4, a vehicle forward collision preventing device 2000 capable of implementing the vehicle forward collision preventing method according to the present disclosure as described above may include an AVN 2100, a communicator 2200, a cluster 2300, a driver 2400, and a controller 2500.

The AVN 2100 may receive navigation information from a navigation terminal mounted in the vehicle. The navigation information may include a road attribute, a speed limit, coordinates, a country, and the like. For example, the navigation information may include information such as a speed limit or the like for each road.

The communicator 2200 may receive real-time traffic information, preceding vehicle speed information, and the like. For example, the communicator 220 may receive the preceding vehicle speed information from a server (not shown) that receives the preceding vehicle speed information in real time.

Specifically, the communicator 2200 may include a communication controller (CCU). The CCU may serve as a connection hub of the vehicle. For example, the CCU may perform CAN/Ethernet communication gateway and controller OTA functions in an in-vehicle area, and may perform vehicle remote and controller FoD functions in an out-vehicle area.

The cluster 2300 may output the inter-vehicle distance, lane recognition, vehicle speed information, and the like to the driver.

For example, the cluster 2300 may provide a notification when the smart cruise control operation is performed and the inter-vehicle distance is adjusted. The cluster 2300 may provide a notification when the inter-vehicle distance adjustment is completed after the smart cruise control operation.

The driver 2400 may perform steering and braking control of the vehicle by supporting integrated functions for travel safety and travel convenience of integrating recognition information of an ADAS sensor via omnidirectional sensor fusion.

The controller 2400 may receive the speed of the preceding vehicle traveling ahead on the travel route, and determine whether there is the road congestion ahead based on the real-time traffic information (a navigation information-based congested area or the like).

The controller 2400 may determine whether there is the congestion by identifying the congestion levels based on the difference between the average speed of the preceding vehicles and the current speed of the vehicle. Here, the congestion levels may be set by reflecting control amounts of the speed and the inter-vehicle distance.

Referring to FIG. 5, the controller 2400 may calculate a stagnation phase d as in Mathematical Formula 1 below (S210).

$$c = a - ( b 1 + b 2 + b 3 … + bn ) / n \qquad [ Mathematical Formula 1 ]$$

Here, a denotes a speed of the vehicle 1000 being driven by the driver, B (b1,b2, b3, . . . , bn) denotes speeds of n preceding vehicles traveling ahead on a route to a destination set by the driver, and c denotes a relative speed between the vehicle 1000 and the preceding vehicles.

The controller 2400 may determine whether the relative speed c exceeds 70% of the speed a of the vehicle 1000 (S220)

When the relative speed c exceeds 70% of the speed a of the vehicle 1000, the controller 2400 may determine the stagnation phase d as a third phase (d=3).

When the relative speed c is equal to or smaller than 70% of the speed a of the vehicle 1000, the controller 2400 may determine whether the relative speed c exceeds 50% of the speed a of the vehicle 1000.

When the relative speed c exceeds 50% of the speed a of the vehicle 1000, the controller 2400 may determine the congested phase d as a second phase (d=2).

When the relative speed c is equal to or smaller than 50% of the speed a of the vehicle 1000, the controller 2400 may determine whether the relative speed c exceeds 30% of the speed a of the vehicle 1000.

When the relative speed c exceeds 30% of the speed a of the vehicle 1000, the controller 2400 may determine the stagnation phase d as a first phase (d=1).

When the relative speed c is is equal to or smaller than 30% of the speed a of the vehicle 1000, the controller 2400 may determine the stagnation phase d as a phase (d=0) at which there is no congestion.

The controller 2400 may set a range for selecting the preceding vehicles in proportion to a maximum speed limit of the road or the speed of the vehicle in operation.

When the congestion ahead is sensed in a traveling direction on the route set in the navigation, the controller 2400 may provide a notification of the congestion ahead to the driver via the cluster 2300.

When the driver does not deactivate the smart cruise control after the congestion notification, the controller 2400 may control the SCC speed based on the congestion level.

The controller 2400 may gradually increase the inter-vehicle distance from a preset level based on the SCC speed. Accordingly, the controller 2400 may control the distance between the vehicle 1000 and the preceding vehicle to increase.

The controller 2400 may calculate the speed of the vehicle 1000 for each congestion level as shown in Mathematical Formula 2 below.

$${a}^{′} = f - f \times ( d \times 0.1 ) \qquad [ Mathematical Formula 2 ]$$

Here, a′ denotes a target speed to be applied to the traveling vehicle 1000, d denotes the congestion level, and f denotes the maximum speed limit of the road.

In addition, the controller 2400 may compare the distance to the preceding vehicle with the changed inter-vehicle distance.

When the distance to the preceding vehicle and the changed inter-vehicle distance are the same, the controller 2400 may restore smart cruise control settings to the speed and the inter-vehicle distance initially set by the driver.

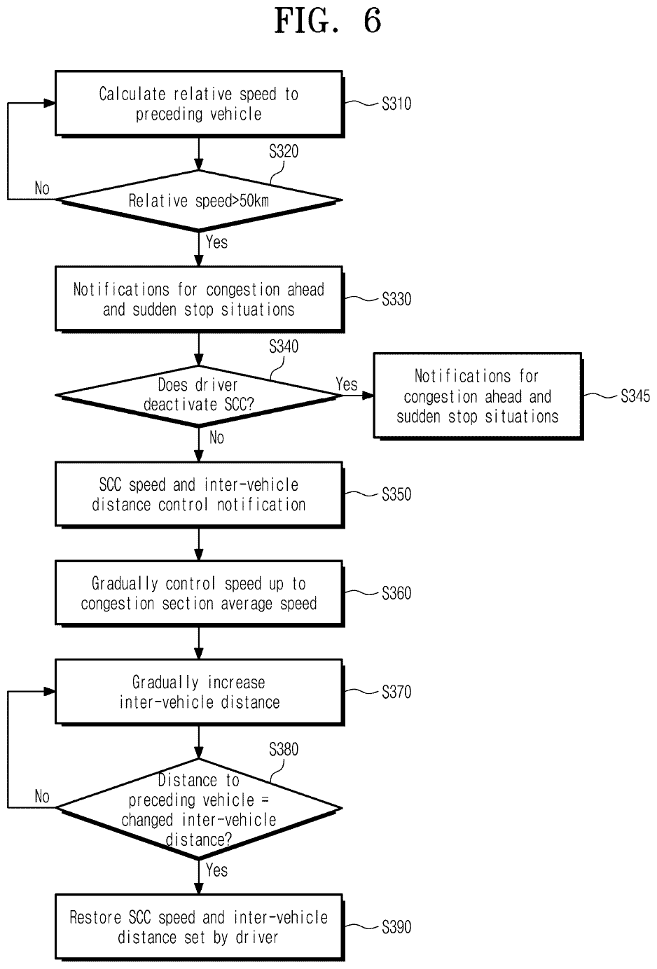

FIG. 6 is a flowchart for illustrating a method for preventing a forward collision of a vehicle according to one of embodiments of the present disclosure.

Referring to FIG. 6, the vehicle forward collision preventing device may calculate the relative speed between the vehicle and the preceding vehicle (S310).

The vehicle forward collision preventing device may determine whether the relative speed between the vehicle and the preceding vehicle exceeds 50 km (S320).

When the relative speed between the vehicle and the preceding vehicle exceeds 50 km, the vehicle forward collision preventing device may output the notifications corresponding to the congestion ahead and sudden stop situations (S330).

The vehicle forward collision preventing device may determine whether to deactivate the SCC based on a driver input (S340). In one example, when the SCC deactivation is input, the vehicle forward collision preventing device may output the notifications for the congestion ahead and sudden stop situations (S345).

When the SCC deactivation is not input, the vehicle forward collision preventing device may output an SCC speed and inter-vehicle distance control notification (S350).

The vehicle forward collision preventing device may gradually control the speed up to a congestion section average speed (S360).

The vehicle forward collision preventing device may gradually increase the inter-vehicle distance (S370).

The vehicle forward collision preventing device may determine whether the inter-vehicle distance changed by gradually increasing is the same as the distance to the preceding vehicle (S380).

When the inter-vehicle distance changed by gradually increasing is the same as the distance to the preceding vehicle, the vehicle forward collision preventing device may control the SCC speed and the inter-vehicle distance set by the driver to be restored (S390).

That is, for the vehicle to use a safer ADAS function while avoiding the forward collision by controlling the smart cruise control using surrounding traffic information as described above, the present disclosure may protect passengers from the forward collision by identifying the congestion situation in advance and controlling the SCC speed and the inter-vehicle distance when there is the congestion at a long distance.

Therefore, the present disclosure is to overcome limitations of the currently configured sensors (a radar and a camera) and safely use the ADAS function, and is able to be implemented via software modification in the currently configured system without additional sensor and controller, so that the smart cruise control function may be more safely used by customers at a minimum cost.

As another aspect of the present disclosure, the above-described proposal or operation of the present disclosure may be provided as a code that may be realized, implemented or executed by a “computer” (a comprehensive concept including a system on chip (SoC), a microprocessor, or the like) or as an application, a computer-readable storage medium, a computer program product, or the like that stores or contains the code, and this also falls within the scope of the present disclosure.

A detailed description of the preferred embodiments of the present disclosure disclosed as above has been provided for those skilled in the art to implement and realize the present invention. Although the description has been made with reference to the preferred embodiments of the present disclosure, those skilled in the art will understand that the present disclosure may be variously modified and changed without departing from the scope of the present disclosure. For example, those skilled in the art may use the components described in the above-described embodiments in a manner of combining them with each other.

Accordingly, the present disclosure is not intended to be limited to the embodiments described herein, but is to be accorded the widest scope consistent with the principles and novel features disclosed herein.

What is claimed is:

1. A method for preventing a forward collision of a vehicle, the method comprising:
receiving preceding traffic information including a location of the vehicle, a travel route, and at least one preceding vehicle speed information;
determining, by a controller, road congestion based on the preceding traffic information;
outputting, by the controller, a congestion notification in response to the road congestion;
determining, by the controller, whether to deactivate smart cruise control in response to the congestion notification;
reducing, by the controller, a speed of the smart cruise control based on that the smart cruise control is not deactivated;
increasing, by the controller, an inter-vehicle distance to a preceding vehicle based on the reduced smart cruise control speed;
determining, by the controller, whether a distance to the preceding vehicle is equal to or smaller than a predetermined distance; and
restoring, by the controller, a predetermined speed and an inter-vehicle distance based on that the distance to the preceding vehicle is equal to or smaller than the predetermined distance.

2. The method of claim 1, wherein the determining of the road congestion based on the preceding traffic information includes:
calculating an average speed based on the at least one preceding vehicle speed information;
calculating a speed difference between the average speed and a current travel speed of the vehicle; and
determining that there is the road congestion based on that the calculated speed difference is equal to or greater than a preset value.

3. The method of claim 2, wherein the reducing of the smart cruise control speed includes:
determining a congestion level based on the calculated speed difference; and
reducing a speed of the vehicle in a stepwise manner based on the determined congestion level.

4. The method of claim 3, wherein the increasing of the inter-vehicle distance based on the reduced smart cruise control speed includes increasing the inter-vehicle distance to the preceding vehicle in a stepwise manner based on the determined congestion level.

5. The method of claim 4, wherein the determining of whether the distance to the preceding vehicle is equal to or smaller than the predetermined distance includes determining whether the distance to the preceding vehicle is the same as the inter-vehicle distance increased in the stepwise manner.

6. A device for preventing a forward collision of a vehicle, the device comprising:
an Audio Video Navigation (AVN) receiving navigation information including a location of the vehicle and a travel route;
a communicator receiving preceding traffic information including at least one preceding vehicle speed information;
a cluster outputting at least one notification;
a driver controlling at least one of a speed and a braking of the vehicle; and
a controller operatively connected to the AVN, the communicator, the cluster, and the driver and controlling at least one of the AVN, the communicator, the cluster, and the driver,
wherein the controller controls the driver to:
determine road congestion based on the preceding traffic information;
output a congestion notification via the cluster in response to the road congestion;
determine whether to deactivate smart cruise control in response to the congestion notification;
reduce a speed of the smart cruise control based on that the smart cruise control is not deactivated;
increase an inter-vehicle distance to a preceding vehicle based on the reduced smart cruise control speed;
determine whether a distance to the preceding vehicle is equal to or smaller than a predetermined distance; and
restore a predetermined speed and an inter-vehicle distance based on that the distance to the preceding vehicle is equal to or smaller than the predetermined distance.

7. The device of claim 6, wherein the controller:
calculates an average speed based on the at least one preceding vehicle speed information;
calculates a speed difference between the average speed and a current travel speed of the vehicle; and
determines that there is the road congestion based on that the calculated speed difference is equal to or greater than a preset value.

8. The device of claim 7, wherein the controller:
determines a congestion level based on the calculated speed difference; and
reduces the speed of the vehicle in a stepwise manner based on the determined congestion level.

9. The device of claim 8, wherein the controller increases the inter-vehicle distance to the preceding vehicle in a stepwise manner based on the determined congestion level.

10. The device of claim 9, wherein the controller determines whether the distance to the preceding vehicle is the same as the inter-vehicle distance increased in the stepwise manner.
